(19) United States
(12) Patent Application Publication
(10) Pub. No.: US 2026/0116018 A1
(43) Pub. Date: Apr. 30, 2026

(54) QUICK-CHANGE LIFTING WELDING HEAD

(71) Applicant: HS Sonic Inc., Irvine, CA (US)

(72) Inventors: Ming LI, Irvine, CA (US); Shengchun CHEN, Irvine, CA (US)

(73) Assignee: HS Sonic Inc., Irvine, CA (US)

(21) Appl. No.: 19/169,241

(22) Filed: Apr. 3, 2025

(30) Foreign Application Priority Data
Oct. 29, 2024 (CN) 202422625572.0

(51) Int. Cl. B29C 65/00; B29C 65/08

(52) U.S. Cl. CPC B29C 66/8167; B29C 65/08; B29C 66/8322

(57) ABSTRACT

A quick-change lifting welding head includes a support structure, a quick positioning structure arranged on the support structure, and an amplitude-transforming welding structure arranged on the quick positioning structure. The quick positioning structure includes a positioning chuck embedded in the support structure and a connecting disc arranged on the positioning chuck. The positioning chuck includes a chuck base and a chuck positioning cover. The chuck positioning cover is equipped with several connection positioning blocks for interfacing with the support structure and positioning holes for interfacing with the connecting disc. One side of the connecting disc is equipped with several connection posts that connect to the amplitude-transforming welding structure, while the other side features positioning posts that connect to the positioning holes. By using the chuck positioning cover and the connecting disc to position and connect the amplitude rod welding structure, the installation can be completed quickly.

### CROSS-REFERENCE TO RELATED APPLICATIONS

This application claims priority to Chinese Patent Application No. 202422625572.0, filed on October 29, 2024, the content of which is incorporated herein by reference in its entirety.

### TECHNICAL FIELD

This application relates to the technical field of ultrasonic welding devices, specifically to a quick-change lifting welding head.

### BACKGROUND

The ultrasonic welding machine is an industrial processing device that converts high-frequency signals into high-frequency mechanical vibrations through a transducer system, transmitting them to the workpiece for heating and welding. It is widely used in the welding and processing of plastic products. The most critical component of the ultrasonic welding machine is the welding head, which is driven by a guide rail to move up and down, thereby bringing the upper mold closer to the lower mold for processing.

Depending on the workpiece and process requirements, different pressures and frequencies must be applied. Before processing, operators need to use measuring tools to replace and adjust the welding head. The welding head requires high assembly precision to ensure the applied pressure and frequency, which often necessitates multiple replacements and adjustments of the welding head position by the operator. This frequent stoppage of the welding head impacts work efficiency.

### SUMMARY

To address the time-consuming and labor-intensive problem of replacing and adjusting the welding head in the related technology, this application provides a quick-change lifting welding head.

A quick-change lifting welding head comprises a supporting structure, a quick positioning structure arranged on the supporting structure, and an amplitude-transforming welding structure arranged on the quick positioning structure. The quick positioning structure includes a positioning chuck fitted into the supporting structure and a connecting disc arranged on the positioning chuck. The positioning chuck consists of a chuck base and a chuck positioning cover, where the chuck positioning cover features several connection positioning blocks for engaging with the supporting structure and positioning holes for engaging with the connecting disc. One side of the connecting disc is equipped with several connecting posts that are linked to the amplitude-transforming welding structure, while the other side of the connecting disc features positioning posts that align with the positioning holes.

Furthermore, the supporting structure includes a first fixed seat and a second fixed seat arranged on the first fixed seat. The second fixed seat is provided with several connection positioning slots designed to engage with the connection positioning blocks. The connection positioning blocks fit into or disengage from the connection positioning slots.

Furthermore, the connection positioning blocks are evenly distributed along the circumferential direction of the chuck positioning cover.

Furthermore, the positioning hole is located at the center of the chuck positioning cover, which is additionally provided with several chuck protrusions arranged along the circumferential direction of the positioning hole. The connection positioning block is equipped with multiple positioning grooves designed to engage with the chuck protrusions, allowing the chuck protrusions and positioning grooves to fit together or disengage.

Furthermore, the amplitude-transforming welding structure includes an amplitude-transforming fixed base connected to the connecting disc, an amplitude rod arranged on the fixed base, an upper mold mounted on the amplitude rod, and a transducer assembly. The connecting posts extend through and are connected to one side of the amplitude-transforming fixed base.

Furthermore, the system also includes a sensing structure, which comprises a sensor fixed base arranged on the supporting structure and a pressure sensor installed on the sensor fixed base.

Furthermore, a protective structure is provided on the outside of the amplitude-transforming welding structure. The protective structure includes a fixed support frame arranged on the supporting structure, a connecting frame attached to the fixed support frame, and a vertical support frame installed on the connecting frame.

This application has the following advantages.

Firstly, the application provides a quick-change lifting welding head. By incorporating a quick positioning structure, the installation of the amplitude-transforming welding structure is simplified. The process involves first connecting the chuck base of the positioning chuck with the chuck positioning cover and positioning it within the supporting structure using the connection positioning blocks on the chuck positioning cover. Subsequently, the amplitude rod welding structure is quickly installed by positioning it with the connecting disc and connecting box. With the assistance of the connection positioning blocks, connecting posts, and positioning posts, positioning is automatically completed during installation, eliminating the need for multiple machine stops for adjustment. This ensures a quick-change mechanism and enhances the operational efficiency of the welding head.

Secondly, the application provides a quick-change lifting welding head. By incorporating a quick positioning structure, the installation of the amplitude-transforming welding structure is simplified. The process involves first connecting the chuck base of the positioning chuck with the chuck positioning cover and positioning it within the supporting structure using the connection positioning blocks on the chuck positioning cover. Subsequently, the amplitude rod welding structure is quickly installed by positioning it with the connecting disc and connecting box. With the assistance of the connection positioning blocks, connecting posts, and positioning posts, positioning is automatically completed during installation, eliminating the need for multiple machine stops for adjustment. This ensures a quick-change mechanism and enhances the operational efficiency of the welding head.

Lastly, the quick-change lifting welding head of this application is also equipped with a sensing structure and a protective structure. The sensing structure enables convenient and rapid measurement of the pressure applied by the amplitude-transforming welding structure, thereby ensuring debugging efficiency. The protective structure safeguards the amplitude-transforming welding structure, preventing positional deviations caused by external forces during installation or debugging.

### BRIEF DESCRIPTION OF THE DRAWINGS

To more clearly illustrate the technical solutions in the embodiments of this application or in the prior art, the drawings required for the description of the embodiments or prior art are briefly introduced below. It is evident that the drawings described below are merely some examples of the embodiments in this application. For those skilled in the art, other drawings can be obtained based on these drawings without creative effort.

FIG. 1 is a schematic diagram of the structure of a quick-change lifting welding head in an embodiment of this application.

FIG. 2 is a schematic diagram of the structure of the quick positioning structure and the amplitude-transforming welding structure in an embodiment of this application.

FIG. 3 is an exploded schematic diagram of the quick positioning structure in an embodiment of this application.

### DETAILED DESCRIPTION OF THE EMBODIMENTS

To make the objectives, features, and advantages of this application more apparent and comprehensible, the specific embodiments of this application are described in detail below with reference to the accompanying drawings. Numerous specific details are provided in the following description to facilitate a thorough understanding of this application. However, this application can be implemented in many ways other than those described herein. Those skilled in the art may make similar modifications without departing from the essence of this application. Therefore, this application is not limited to the specific embodiments disclosed below.

In addition, the terms "first" and "second" are used solely for descriptive purposes and should not be understood as indicating or implying relative importance or suggesting a specific quantity of the referenced technical features. Accordingly, features designated as "first" or "second" may explicitly or implicitly include at least one of such features. In the description of this application, the term "multiple" means at least two, such as two, three, etc., unless explicitly and specifically defined otherwise.

In this application, unless explicitly specified or defined otherwise, terms such as "install," "connect," "attach," "fix," and the like should be interpreted broadly. For example, they may refer to a fixed connection, a detachable connection, or an integral connection. It may refer to a mechanical connection or an electrical connection; it may be a direct connection or an indirect connection through an intermediate medium. It can also refer to internal communication within two components or an interaction between two components, unless explicitly defined otherwise. A person of ordinary skill in the art can understand the specific meaning of the above terms in this application based on the specific context.

In this application, unless explicitly specified or defined otherwise, the first feature being "on" or "under" the second feature may refer to direct contact between the first and second features, or indirect contact through an intermediate medium. Furthermore, the first feature being "above," "over," or "on top of" the second feature may mean that the first feature is directly or diagonally above the second feature, or it may simply indicate that the first feature is at a higher horizontal level than the second feature. The first feature being "below," "under," or "beneath" the second feature may mean that the first feature is directly or diagonally beneath the second feature, or it may simply indicate that the first feature is at a lower horizontal level than the second feature.

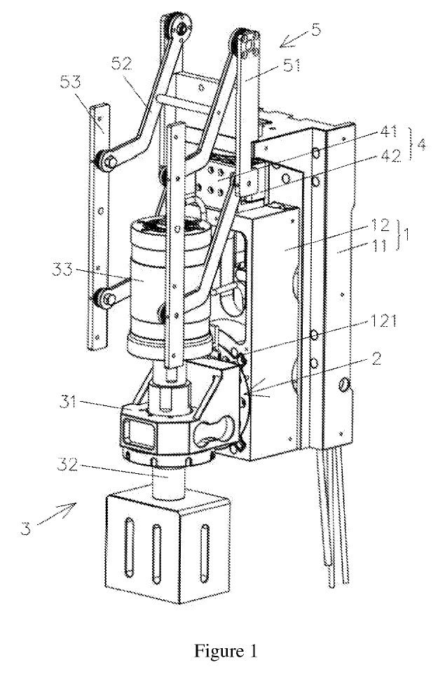

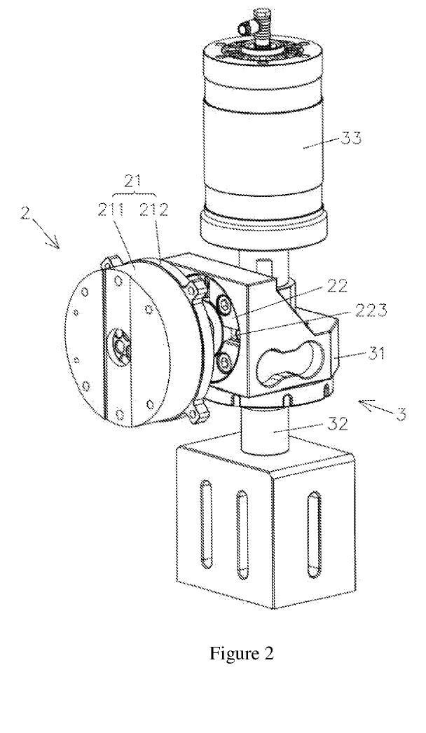

Referring to FIGS. 1 and 2, a quick-change lifting welding head comprises a support structure 1, a quick positioning structure 2 arranged on the support structure 1, and an amplitude-adjustable welding structure 3 arranged on the quick positioning structure 2. The quick-change positioning structure allows for rapid installation and alignment of the amplitude-adjustable welding structure 3 without the need for frequent disassembly and adjustment after installation, thereby ensuring the operational efficiency of the welding head.

Specifically, the support structure 1 is used to support and mount the quick positioning structure 2 and the amplitude-adjustable welding structure 3. The support structure 1 includes a first fixed base 11 and a second fixed base 12 arranged on the first fixed base 11. Both the first fixed base 11 and the second fixed base 12 are positioned vertically, with the second fixed base 12 located on one side of the first fixed base 11.

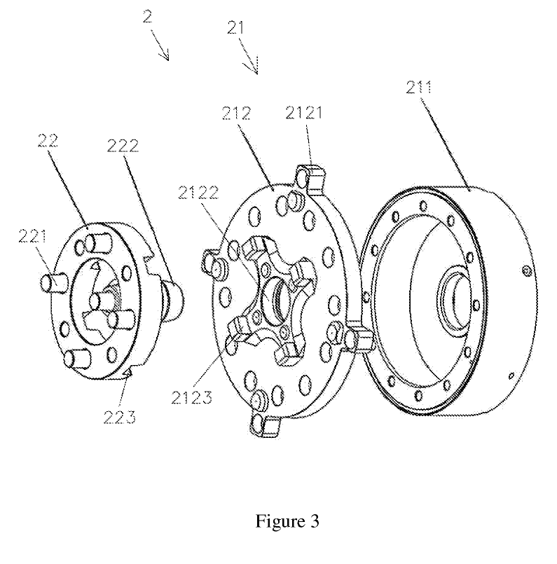

Referring to FIGS. 2 and 3, the quick positioning structure 2 includes a positioning chuck 21 embedded in the support structure 1 and a connection disc 22 arranged on the positioning chuck 21. The positioning chuck 21 comprises a chuck base 211 mounted in the second fixed base 12 and a chuck positioning cover 212. The chuck base 211 and the chuck positioning cover 212 are fixedly installed and detachable through a threaded connection. Specifically, the second fixed base 12 has a groove, the shape of which matches that of the positioning chuck 21. The chuck base 211 and the chuck positioning cover 212 are embedded in this groove.

For positioning purposes, the chuck positioning cover 212 is equipped with several connecting positioning blocks 2121 designed to engage with the support structure 1 and positioning holes 2122 designed to engage with the connection disc 22. The connecting positioning blocks 2121 are evenly arranged along the circumferential direction of the chuck positioning cover 212. The second fixed base 12 is provided with several connection positioning grooves 121, the number of which matches the number of connecting positioning blocks 2121 in a one-to-one correspondence. The connecting positioning blocks 2121 engage with or disengage from the connection positioning grooves 121. By aligning the groove and the connection positioning grooves 121 and inserting the positioning chuck 21, the installation and alignment of the positioning chuck 21 can be achieved.

The connection disc 22 is fitted and mounted on the side of the positioning chuck 21 that is opposite to the second fixed base 12. To facilitate connection with the positioning chuck 21 and the amplitude-adjustable welding structure 3, one side of the connection disc 22 is equipped with several connecting posts 221 for linking with the amplitude-adjustable welding structure 3, while the other side of the connection disc 22 features positioning posts 222 that connect to the positioning holes 2122. Specifically, the positioning post 222 is located at the center of the connection disc 22 and faces the chuck positioning cover 212. The positioning hole 2122 is positioned at the center of the chuck positioning cover 212, and the positioning post 222 is slidably connected to the positioning hole 2122. Additionally, the chuck positioning cover 212 is further provided with several chuck protrusions 2123 arranged circumferentially around the positioning hole 2122. The connecting positioning block 2121 is equipped with several positioning grooves 223 designed to engage with the chuck protrusions 2123. The chuck protrusions 2123 and the positioning grooves 223 can either engage or disengage.

By providing the positioning post 222 and the positioning grooves 223, the installation of the connection disc 22 is accomplished by aligning the positioning post 222 and the positioning grooves 223 of the connection disc 22 with the positioning hole 2122 and the chuck protrusions 2123, respectively, and inserting them. This completes the installation and alignment process. Subsequently, the connection disc 22 can be fixed onto the positioning chuck 21. The fixing method can involve threaded connections or pneumatic clamping.

The amplitude-changing welding structure 3 includes an amplitude-transforming fixed base 31 connected to the connection disc 22, an amplitude rod 32 arranged on the amplitude-transforming fixed base 31, an upper mold arranged on the amplitude rod 32, and a transducer assembly 33. The amplitude-transforming fixed base 31 is vertically arranged, with one side of the amplitude-transforming fixed base 31 featuring an adaptation groove and an adaptation hole designed to accommodate the connection disc 22 and the connecting post 221. The connection disc 22 is embedded into the adaptation groove, while the connecting post 221 passes through and connects to the adaptation hole on the same side of the amplitude-transforming fixed base 31. The amplitude-transforming fixed base 31 includes a hole for mounting the amplitude rod 32, with the axis of the hole positioned vertically. The upper mold is installed at the lower end of the amplitude rod 32, and the transducer assembly 33 is installed at the upper end of the amplitude rod 32.

Referring back to FIG. 1, the quick-change lifting welding head further includes a sensing structure 4. The sensing structure 4 comprises a sensing fixed base 41 arranged on the supporting structure 1 and a pressure sensor 42 installed on the sensing fixed base 41. When the amplitude-changing welding structure 3 drives the upper mold to contact the lower mold for welding, the pressure sensor 42 can instantly monitor the pressure applied to the amplitude-changing welding structure 3, enabling operators to easily obtain the pressure parameters and make corresponding adjustments.

To protect the amplitude modulation welding structure 3, the quick-change lifting welding head also includes a protective structure 5 located on the outer side of the amplitude modulation welding structure 3. The protective structure 5 comprises a fixed support frame 51 set on the support structure 1, a connecting frame 52 attached to the fixed support frame 51, and a vertical support frame 53 mounted on the connecting frame 52. The protective structure 5 can protect the amplitude modulation welding structure 3, preventing any positional displacement of the amplitude modulation welding structure 3 due to external forces during installation or adjustment.

The technical features described in the above embodiments can be combined in any manner. To keep the description concise, not all possible combinations of the technical features in the aforementioned embodiments are described. However, as long as there is no contradiction in these combinations, they should be considered within the scope documented in this specification.

The embodiments described above represent only a few possible implementations of this application and are described in specific and detailed terms, but this should not be construed as limiting the scope of the patent application. It should be noted that for those skilled in the art, several modifications and improvements can be made without departing from the concept of this application, and these are within the scope of protection of this application. Therefore, the protection scope of this patent application should be determined by the appended claims.

What is claimed is:

1. A quick-change lifting welding head, comprising a support structure, a quick positioning structure arranged on the support structure and an amplitude-transforming welding structure arranged on the quick positioning structure; wherein,
the quick positioning structure comprises a positioning chuck embedded in the support structure and a connecting disc arranged on the positioning chuck;
the positioning chuck comprises a chuck base and a chuck positioning cover, the chuck positioning cover is provided with several connecting positioning blocks for matching the support structure and positioning holes for matching the connecting disc; and
one side of the connecting disc is provided with several connecting posts connected to the amplitude-transforming welding structure, while the other side of the connecting disc is provided with positioning posts connected to the positioning holes.

2. The quick-change lifting welding head according to claim 1, wherein,
the support structure comprises a first fixing base and a second fixing base arranged on the first fixing base;
the second fixing base is provided with several connection positioning grooves configured to fit with the connecting positioning blocks; and
the connecting positioning blocks engage with or detach from the connection positioning grooves.

3. The quick-change lifting welding head according to claim 2, wherein the connecting positioning blocks are uniformly arranged along a circumferential direction of the chuck positioning cover.

4. The quick-change lifting welding head according to claim 1, wherein,
the positioning hole is located at a center of the chuck positioning cover, and the chuck positioning cover is further provided with several chuck protrusions arranged along a circumferential direction of the positioning hole; and
the connecting positioning blocks are provided with several positioning grooves configured to fit with the chuck protrusions, the chuck protrusions engage with or detach from the positioning grooves.

5. The quick-change lifting welding head according to claim 1, wherein,
the amplitude-transforming welding structure comprises an amplitude-transforming fixed base connected to the connecting disc, an amplitude rod arranged on the amplitude-transforming fixed base, an upper mold provided on the amplitude rod, and a transducer assembly; and
the connecting posts pass through and are connected to one side of the amplitude-transforming fixed base.

6. The quick-change lifting welding head according to claim 1, further comprising a sensing structure, wherein the sensing structure comprises a sensing fixed base arranged on the supporting structure and a pressure sensor arranged on the sensing fixed base.

7. The quick-change lifting welding head according to claim 1, further comprising a protective structure arranged on the outside of the amplitude-transforming welding structure, wherein the protective structure comprises a fixed support frame arranged on the supporting structure, a connecting frame connected to the fixed support frame, and a vertical support frame arranged on the connecting frame.
